(19) United States
(12) Patent Application Publication
(10) Pub. No.: US 2010/0062816 A1
(43) Pub. Date: Mar. 11, 2010

(54) Mobile phone protective cover

(76) Inventor: Hsin Yuan Yu, Pyng-Jenn City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,563

(22) Filed: Aug. 17, 2009

(30) Foreign Application Priority Data
Sep. 5, 2008 (TW) 097216048

(51) Int. Cl. H04M 1/00

(52) U.S. Cl. 455/575.8

(57) ABSTRACT

An improved mobile phone protective cover includes a plastic plate spread open and cut according to the shape of a mobile phone, and a lining and an external decorative element covered onto inner and outer layers of the plastic plate respectively. The plastic plate with the lining and the external decorative element includes a wing portion formed according to the shape of the mobile phone, and the wing portions are formed by bending the latch portions. The latch portions are fixed and combined with the periphery of the mobile phone directly and securely, and the protective cover can be combined integrally with the mobile phone in a simple and easy way without occupying much space, and achieve the purpose and effect of protecting the mobile phone.

### BACKGROUND OF THE INVENTION

1. Field of the Invention

The present invention relates to an improved mobile phone protective cover, and more particularly to an improved mobile phone protective cover having a simple structure occupying not much space, featuring a low cost and a simple use, and providing an aesthetic and protective effect of a stylish mobile phone, and the mobile phone protective cover of the invention is novel, practical and useful.

2. Description of the Related Art

Since a mobile phone is wireless and portable, and users generally place and access the mobile phone anywhere and anytime, surfaces of the mobile phone are worn and damaged or the mobile phone is dropped by accident easily. As a result, various types of mobile phone protective covers such as a mobile phone bag hung around a user's neck, put into the user's bag, or hung at a user's belt are introduced into the market. However, the aforementioned mobile phone bag or cover is separated from the mobile phone during a use of the mobile phone, and thus the surfaces of the mobile phone are still worn and damaged easily, and the mobile phone cannot be protected when it is dropped onto the floor by accident, and such mobile phone bag or cover still cannot achieve the protecting effect. Since the mobile phone has to be taken out or put into the mobile phone bag or cover frequently, the operation is relatively troublesome and inconvenient. Particularly, the mobile phone cover hung at the user' belt is made of a hard material and an accessory such as a magnetic buckle for hanging the mobile phone at the user's belt is required, and thus the protective covers of this sort have the drawbacks of incurring a higher manufacturing cost, occupying much space, and causing electromagnetic interference. Of course, related manufacturers also provide an integrally formed mobile phone cover, wherein a casing of a mobile phone is produced by an injection molding process according to the external appearance of the mobile phone, and a decorative material (such as a skin layer) is attached onto the surface of the casing, and then the mobile phone is accommodated into the casing to achieve the effects of integrating the protective casing with the mobile phone to prevent the mobile phone from being damaged by an accidental drop of the mobile phone. Although such arrangement can achieve the aforementioned effects, yet the casing requires a mold for the injection molding process, not only requiring a complicated manufacturing process of manufacturing the mold and attaching the decorative material, but also incurring a high manufacturing cost, and thus this manufacture is not used extensively by manufacturers.

In view of the aforementioned shortcomings, the inventor of the present invention based on years of experience in the related industry to conduct extensive researches and experiments, and finally developed an improved mobile phone protective cover in accordance with the present invention.

### SUMMARY OF THE INVENTION

It is a primary objective of the present invention to provide an improved mobile phone protective cover, wherein a wing portion of a precut plastic plate with a lining and an external decorative element is bent directly to form a latch portion, and the latch portion is latched onto the periphery of a mobile phone, and the protective cover can be integrated with the mobile phone as a whole conveniently and securely without occupying much space, and the protective cover can achieve the purpose and effect of protecting the mobile phone.

Another objective of the present invention is to provide an improved mobile phone protective cover, wherein the precut plastic plate together with the lining and the external decorative element are sewed or attached with each other on a plane, not only providing a simple, easy, convenient and quick way of producing the mobile phone protective cover to achieve the expected effects of a high-quality and cost-effective protective cover.

A further objective of the present invention is to provide an improved mobile phone protective cover having a simple structure occupying not much space, featuring a low cost and a simple use, and providing aesthetic and protective effects for a stylish mobile phone. Such mobile phone protective cover is novel, practical and useful.

To make it easier for our examiner to understand the objects, effects and advantages of the present invention, we use preferred embodiments with related drawings for the detailed description of the present invention as follows.

### BRIEF DESCRIPTION OF THE DRAWINGS

FIG. 1 is a top view of a plastic plate with a lining and an external decorative element spread open in accordance with a preferred embodiment of the present invention;

FIG. 2 is a front view of FIG. 1;

FIG. 3 is a schematic view of a mobile phone protective cover in accordance with a preferred embodiment of the present invention;

FIG. 4 is a cross-sectional view of a mobile phone protective cover installed onto a mobile phone in accordance with a preferred embodiment of the present invention; and

FIG. 5 is a perspective view of a mobile phone protective cover installed and combined with a mobile phone in accordance with a preferred embodiment of the present invention.

### DETAILED DESCRIPTION OF THE PREFERRED EMBODIMENTS

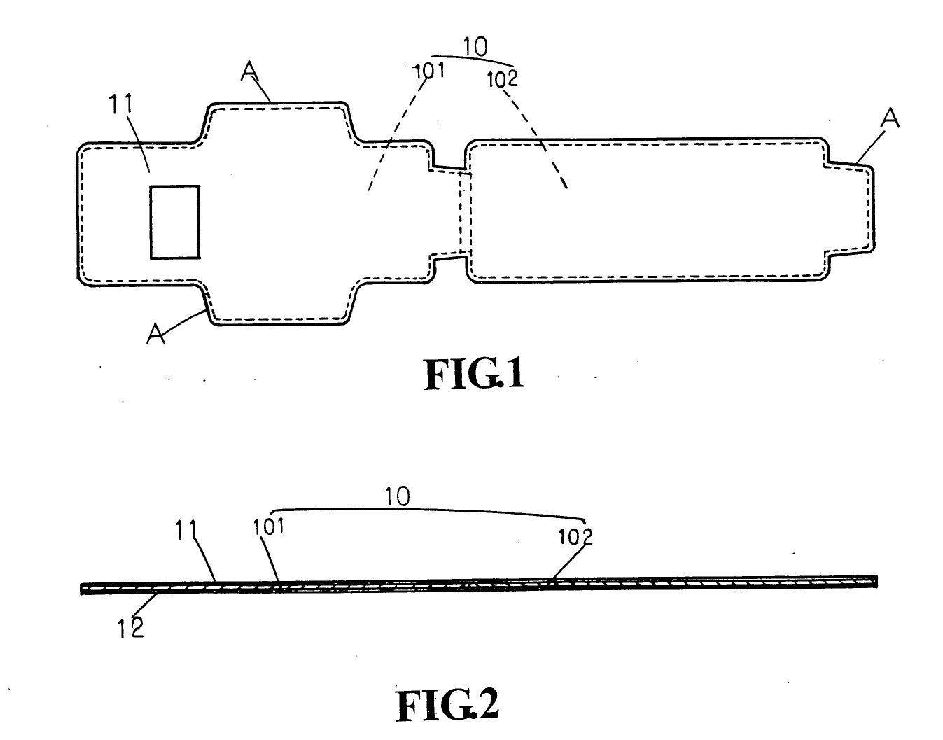

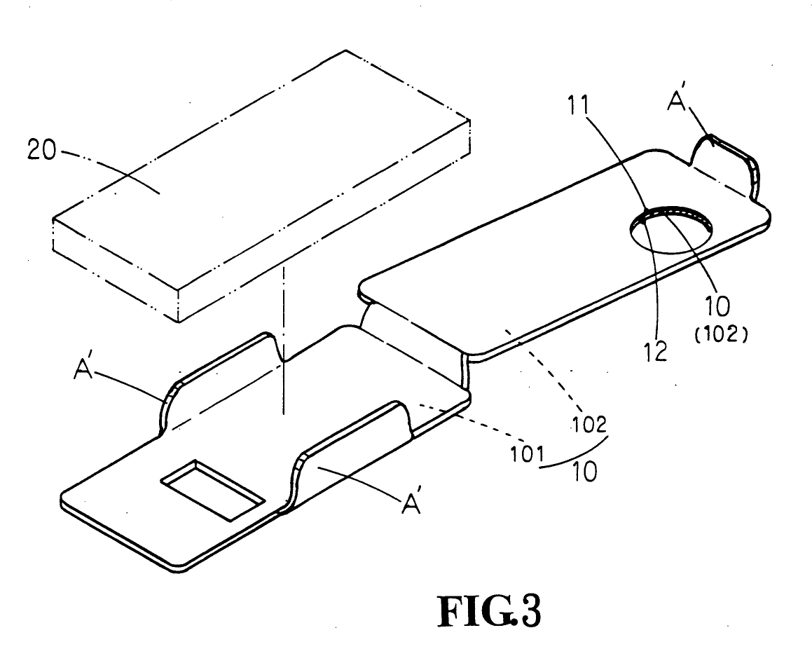

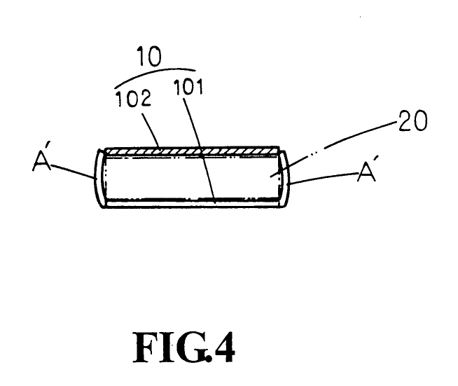

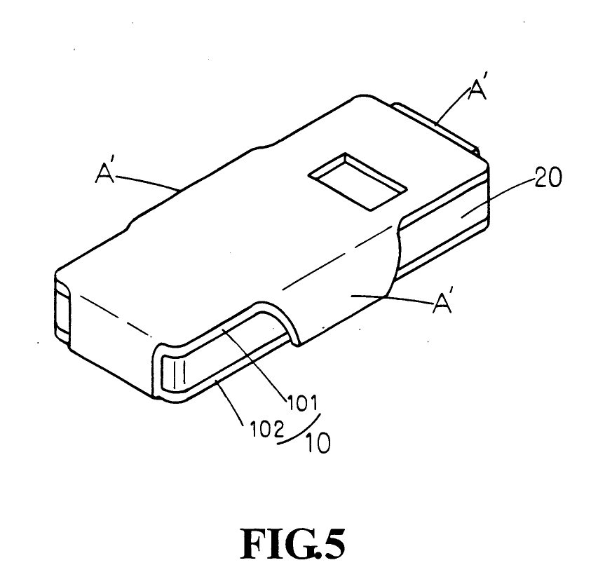

With reference to FIGS. 1 to 3 for an improved mobile phone protective cover of the present invention, the mobile phone protective cover comprises a plastic plate 10 (such as a PE plate) and a lining 11 and an external decorative element 12 disposed at inner and outer layers of the plastic plate 10 respectively, and the plastic plate 10 with the lining 11 and the external decorative element 12 is spread open and cut according to the shape of the mobile phone 20, and a plurality of wing portions A is extended outwardly from the periphery of the plastic plate 10 and are sewed or attached integrally as a whole. The plastic plate 10 is a single plate formed according to the shape of the mobile phone or composed of two plates (such as plastic plates 101, 102 as shown in the figure) or a plurality of plates folded with each other, and the lining 11 and the external decorative element 12 are covered directly onto the plastic plate 10. A wing portion A of the integrally formed plastic plate 10, lining 11 and external decorative element 12 is bent towards the lining 11 to form a latch portion A′ (as shown in FIG. 4), such that the wing portion A is latched to the periphery of the mobile phone 20 and integrated with the mobile phone 20 as a whole (as shown in FIG. 5).

With the aforementioned structure, A wing portion A of the integrally formed plastic plate 10, lining 11 and external decorative element 12 is bent directly to form the latch portion A′ and latched directly to the corresponding periphery of the mobile phone 20, such that the wing portion A is integrated with the mobile phone 20, and the mobile phone 20 can achieve the protecting effect without changing the shape or occupying much space (except a slight increase of volume only). Particularly, the plastic plate 10 is made of a hard material, the mobile phone 20 can have a better drop-resisting effect. Of course, the wing portion A of the plastic plate 10 can be bent into the predetermined latch portion A′ by a simple and convenient baking process, and the plastic plate 10, lining 11 and external decorative element 12 can be precut on a plane, sewed or attached integrally as a whole in advance, and thus the manufacture is simple, easy, convenient and quick, and the use is safe and secure, so as to provide a high and reliable quality of the mobile phone protective cover.

The lining 11 is made of a soft material (such as fabric or leather ), not only protecting a mobile phone casing, but also providing a way of wiping a display screen of the mobile phone to achieve diversified effects.

What is claimed is:

1. An improved mobile phone protective cover, comprising a plastic plate, and a lining and an external decorative element disposed at inner and outer layers of the plastic plate respectively, characterized in that the plastic plate with the lining and the external decorative element is spread open according to an external shape of a mobile phone and integrated as a whole, and a plurality of wing portions extended externally and formed at the periphery of the plastic plate, and the wing portions are bent towards the lining to form a plurality of latch portions, and the latch portions are latched to the periphery of the mobile phone and integrally formed with the mobile phone.

2. The improved mobile phone protective cover of claim 1, wherein the plastic plate is formed by a single plate designed according to the shape of the mobile phone, or two or more plates folded together with one another.

3. The improved mobile phone protective cover of claim 1, wherein the plastic plate with the lining and the external decorative element are sewed or attached integrally.

4. The improved mobile phone protective cover of claim 1, wherein the lining is made of a soft fabric or leather.
